(19) United States
(12) Patent Application Publication
(10) Pub. No.: US 2025/0357843 A1
(43) Pub. Date: Nov. 20, 2025

(54) BOOST CONVERTER WITH BYPASS TRANSISTOR

(71) Applicant: TEXAS INSTRUMENTS INCORPORATED, Dallas, TX (US)

(72) Inventors: Chen Feng, Shanghai (CN); Jian Liang, Shanghai (CN); Guangxu Wang, Wuxi (CN); Jing Ji, Hangzhou (CN)

(21) Appl. No.: 18/664,361

(22) Filed: May 15, 2024

(51) Int. Cl. H02M 1/00; H02M 3/07

(52) U.S. Cl. CPC H02M 1/0095; H02M 1/0083; H02M 3/07

(57) ABSTRACT

A circuit includes a first transistor having a first terminal and a second terminal. The circuit includes a second transistor having a first terminal and a second terminal. The first terminal of the second transistor is coupled to the first terminal of the first transistor. A third transistor has a first terminal and a second terminal. The second terminal of the third transistor is coupled to the second terminal of the second transistor. A charge pump has an output coupled to the first terminal of the third transistor. A capacitor has a terminal coupled to the first terminal of the first transistor and to the first terminal of the second transistor.

### BACKGROUND

A boost converter is a direct current (DC)-to-DC switching power converter that generates a regulated output voltage that is larger than the input voltage to the boost converter. An application for use of a boost converter is in a battery-operated device (e.g., cellular mobile device such as a smart phone, tablet device, etc.). The input voltage to the boost converter is from the battery. As the battery discharges its stored energy, its voltage decreases. The boost converter is useful in such devices to boost the battery's voltage for powering circuits in the battery-operated device. However, when the battery is fully or nearly fully charged, the boost converter is not needed. Accordingly, a boost converter may include a bypass switch (e.g., a transistor) which, when closed, allows the battery's voltage to bypass the boost converter as the output voltage from the power converter. Such power converters have a bypass mode and a boost mode. When the input voltage to the power converter is above a threshold, the bypass switch is turned on, and the boost converter is turned off. When the input voltage is below the threshold, the bypass switch is turned off, and the boost converter is turned on.

### SUMMARY

In one example, a circuit includes a first transistor having a first terminal and a second terminal. The circuit includes a second transistor having a first terminal and a second terminal. The first terminal of the second transistor is coupled to the first terminal of the first transistor. A third transistor has a first terminal and a second terminal. The second terminal is coupled to the second terminal of the second transistor. A charge pump has an output coupled to the first terminal of the third transistor. A capacitor has a terminal coupled to the first terminal of the first transistor and to the first terminal of the second transistor.

### BRIEF DESCRIPTION OF THE DRAWINGS

FIG. 1 is a block diagram of a power converter including a boost converter, a bypass transistor, a high side and bypass driver, and a charge pump circuit, in an example.

FIG. 2 are graphs illustrating input voltage to and output voltage from the power converter of FIG. 1.

FIG. 3 is a schematic diagram of the high side and bypass driver of FIG. 1, in an example.

FIG. 4 are waveforms illustrating the operation of a level shifter included in the high side and bypass driver of FIG. 3, in an example.

FIG. 5 is a schematic diagram of the level shifter included in the high side and bypass driver of FIG. 3, in an example.

FIG. 6 is a schematic diagram of the high side bypass driver of FIG. 3 illustrating which transistors are on and which are off during the boost mode for which a high side transistor is off, in an example.

FIG. 7 is a schematic diagram of the high side bypass driver of FIG. 3 illustrating which transistors are on and which are off during the boost mode for which the high side transistor is on, in an example.

FIG. 8 is a schematic diagram of the high side bypass driver of FIG. 3 illustrating which transistors are on and which are off during a transition phase between the boost mode and the bypass mode, in an example.

FIG. 9 is a graph illustrating the gate signal produced by the high side and bypass driver to the bypass transistor, in an example.

FIG. 10 is a schematic diagram of the high side bypass driver of FIG. 3 illustrating which transistors are on and which are off during the bypass mode, in an example.

FIG. 11 is a schematic diagram of the charge pump circuit, in an example.

### DETAILED DESCRIPTION

The same reference numbers or other reference designators are used in the drawings to designate the same or similar (either by function and/or structure) features.

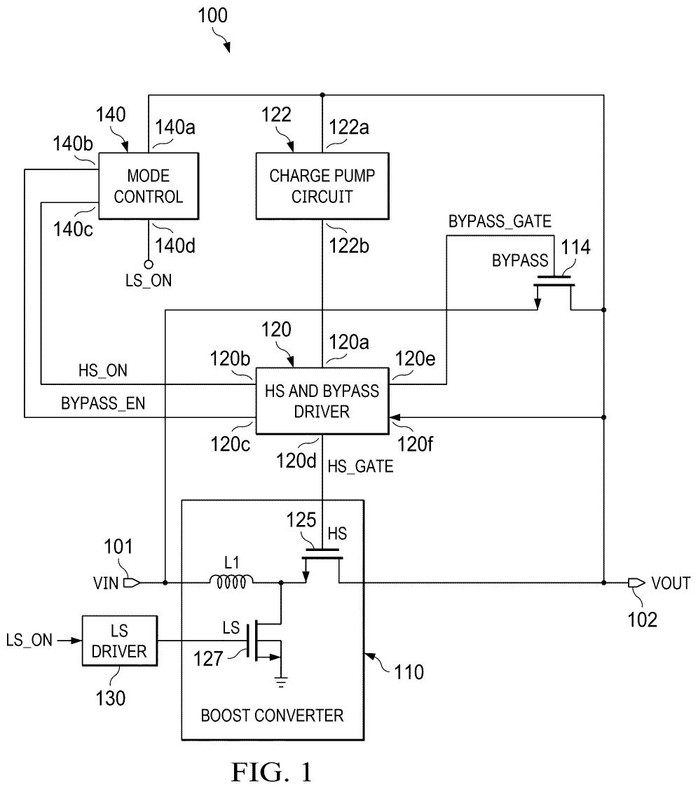

FIG. 1 is a block diagram of a power converter 100 which includes a boost converter 110, a bypass transistor 114, a high side (HS) and bypass driver 120, a charge pump circuit 122, a low side (LS) driver 130, and a mode controller circuit 140. Power converter 100 includes an input 101 and an output 102. An input voltage VIN, from a battery or other type of power source, is provided to input 101. Power converter 100 generates an output voltage VOUT at output 102. In this example, bypass transistor 114 is an n-channel field effect transistor (NFET). Boost converter 110 includes an HS transistor 125, an LS transistor 127, and an inductor L1. In this example, both the HS transistor 125 and the LS transistor 127 are NFETs.

The components shown in FIG. 1 may all be fabricated on the same integrated circuit (IC). In another example, all of the components except inductor L1 are fabricated on the same IC, and inductor L1 is an external component with respect to the IC.

In this example, one terminal of inductor L1 is coupled to the input 101, and the other terminal of inductor L1 is coupled to the source of HS transistor 125 and to the drain of transistor 127. The drain of HS transistor 125 is coupled to the output 102. The source of LS transistor 127 is coupled to ground. The source of bypass transistor 114 is coupled to the input 101, and the drain of bypass transistor 114 is coupled to the output 102. When bypass transistor 114 is turned on, current from the input 101 flows through bypass transistor 114 to the output 102 thereby bypassing boost converter 110.

Mode control circuit 140 has an input 140a and outputs 140b, 140c, and 140d. Mode control circuit 140 generates a signal BYPASS_EN at output 140b, a signal HS_ON at output 140c, and a signal LS_ON at output 140d. HS and bypass driver 120 has inputs 120a, 120b, 120c, and 120f and outputs 120d and 120c. Charge pump circuit 122 has an input 122a and an output 122b. Inputs 122a and 140a of charge pump circuit 122 and mode control circuit 140, respectively, are coupled to output 102 and receive output voltage VOUT. Charge pump circuit 122 generates an output voltage that is, in one example, 5V larger than its input voltage, VOUT. Accordingly, the output 122b from charge pump circuit 122 has a voltage equal to VOUT+5V. Outputs 140b and 140c of mode control circuit 140 are coupled to inputs 120b and 120c of HS and bypass driver 120. Output 140d of mode control circuit 140 is coupled to an input of LS driver 130. The output of LS driver 130 is coupled to the gate of LS transistor 127. Outputs 120d and 120e of HS and bypass driver 120 are coupled to the gates of HS transistor 125 and bypass transistor 114, respectively. The output 122b of charge pump circuit 122 is coupled to input 120a of HS and bypass driver 120. Output 102 of power converter 100 is coupled to input 120f of HS and bypass driver 120.

When bypass transistor 114 is turned on, the output voltage VOUT is approximately equal to the input voltage VIN. Mode control circuit 140 determines whether the output voltage VOUT is above or below a threshold. In response to determining that the output voltage VOUT is above the threshold, mode control circuit 140 asserts signals BYPASS_EN, HS_ON, and LS_ON to logic levels that causes HS and bypass driver 120 to maintain bypass transistor 114 on and maintaining HS transistor 125 off and causes LS driver 130 to maintain LS transistor 127 off. Accordingly, when the output voltage VOUT is above the threshold, boost converter 110 is turned off and bypass transistor 114 is turned on.

In response to determining that output voltage VOUT is below threshold, mode control circuit 140 asserts signal BYPASS to a logic level that causes HS and bypass driver 120 turn bypass transistor 114 off. Further, mode control alternately toggles signals HS_ON and LS_ON to the respective gates of HS transistor 125 and LS transistor 127 to enable operation of boost converter 110.

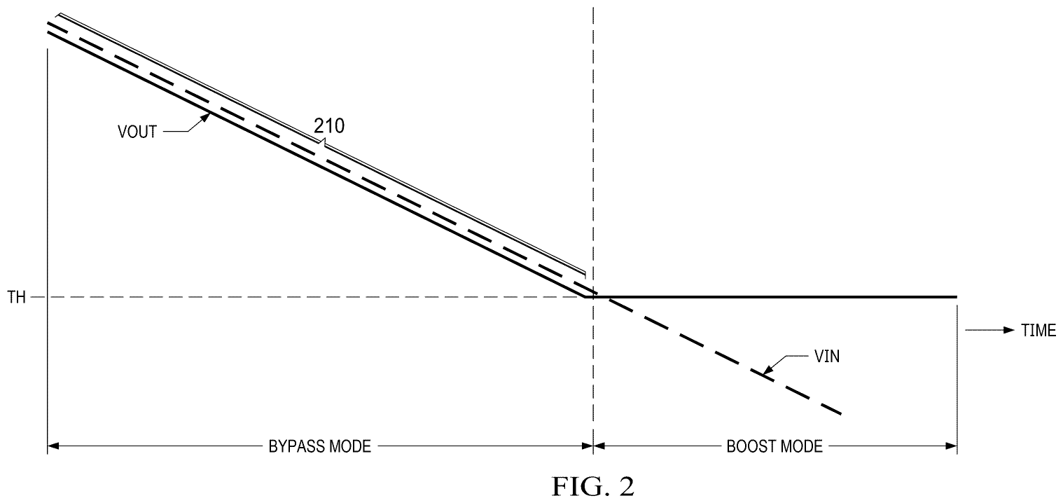

FIG. 2 are graphs of input voltage VIN and output voltage VOUT with respect to time. Input voltage VIN decreases due to, for example, a battery becoming depleted. While input voltage VIN is above the threshold (TH), power converter 100 operates in the bypass mode with HS and bypass driver turning bypass transistor 114 on. Accordingly, output voltage VOUT is approximately equal to input voltage VIN as indicated at 210.

In response to input voltage VIN falling below the threshold, power converter 100 operates in boost mode with mode control circuit 140 alternately toggling on and off signals HS_ON and LS_ON to the gates of HS transistor 125 and LS transistor 127 to thereby regulate output voltage VOUT at approximately the level of the threshold despite a further decrease in input voltage VIN.

With power converter 100 operating in the bypass mode, current through the power converter from the input 101 to the output 102 flows through bypass transistor 114. For the same drain current, an NFET has a lower on-resistance than a p-channel field effect transistor (PFET). Accordingly, bypass transistor 114 advantageously is an NFET instead of a PFET. By implementing the bypass transistor as an NFET, a lower resistance is present in the current path through power converter 100 during the bypass mode compared to the resistance that would be present if bypass transistor was a PFET.

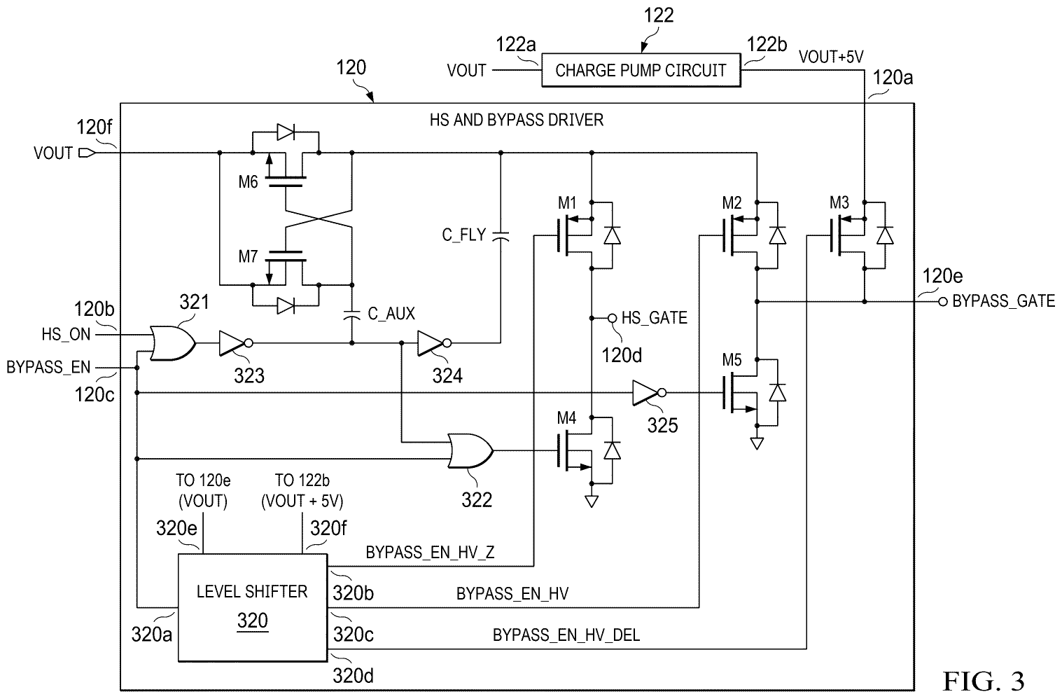

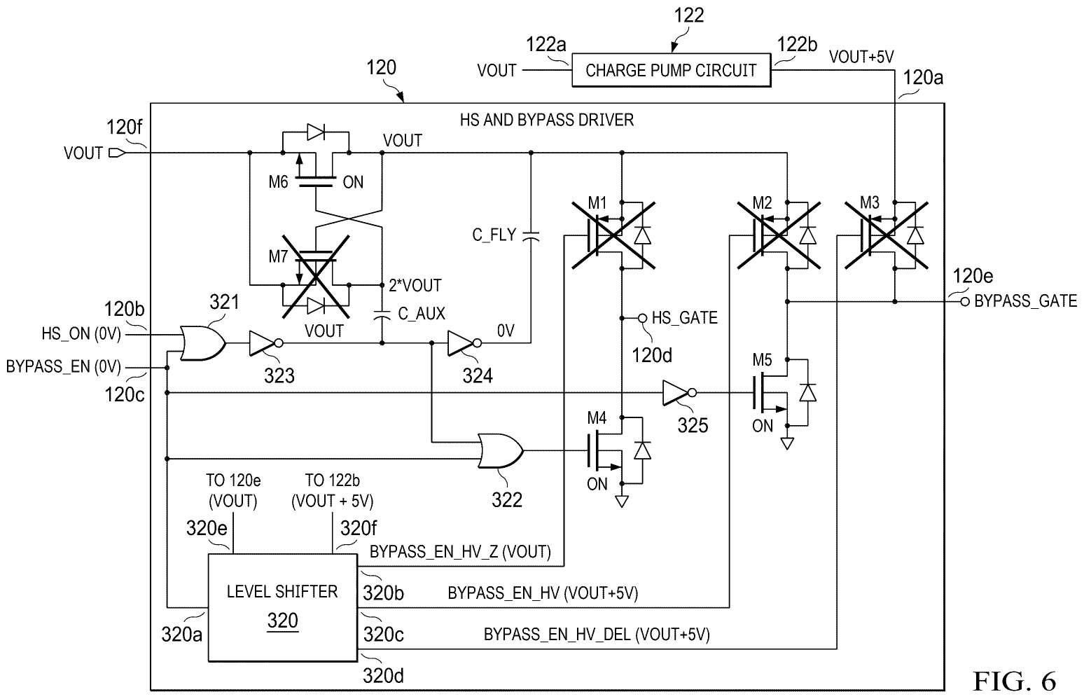

FIG. 3 is a schematic diagram of HS and bypass driver 120. The operation of the HS and bypass driver 120 of FIG. 3 is explained below with respect to FIGS. 6-10. In the example of FIG. 3, HS and bypass driver 120 includes transistors M1, M2, M3, M4, M5, M6, and M7, a level shifter 320, OR gates 321 and 322, inverters 323, 324, and 325, and capacitors C_AUX and C_FLY. Transistors M1-M3 are PFETs, and transistors M4-M7 are NFETs. Inputs 120b and 120c are coupled to respective inputs of OR gate 321. Accordingly, OR gate 321 logically ORs together signals HS_ON and BYPASS_EN. The output of OR gate 321 is coupled to the input of inverter 323. The output of inverter 323 is coupled to the input of inverter 324 and to an input of OR gate 322. The other input of OR gate 322 is coupled to input 120c.

One terminal of capacitor C_AUX is coupled to the output of inverter 323, and the other terminal of capacitor C_AUX is coupled to the gate of transistor M6 and the drain of transistor M7. The sources of transistors M6 and M7 are coupled together and to input 120f and, accordingly, receive the output voltage VOUT. One terminal of capacitor C_FLY is coupled to the output of inverter 324, and the other terminal of capacitor C_FLY is coupled to the drain of transistor M6, the gate of transistor M7, and the sources of transistors M1 and M2.

The drains of transistors M1 and M4 are coupled together and to output 120d, which provides the signal HS_GATE to the gate of HS transistor 125 (FIG. 1). The drains of transistors M2, M3, and M5 are coupled together and to output 120c, which provides the signal BYPASS_GATE to the gate of bypass transistor 114. The input of inverter 325 is coupled to input 120c and receives signal BYPASS_EN. The output of inverter 325 is coupled to the gate of transistor M5. The source of transistor M3 is coupled to input 120a, which is coupled to output 122b of charge pump circuit 122.

Level shifter 320 has an input 320a and outputs 320b, 320c, and 320d. Input 320a is coupled to input 120c and receives signal BYPASS_EN. Outputs 320b, 320c and 320d are coupled to the gates of transistors M1, M2, and M3, respectively. Level shifter 320 generates signal BYPASS_EN_HV_Z at output 320b, signal BYPASS_EN_HV at output 320c, and signal BYPASS_EN_HV_DEL at output 320d. Signals BYPASS_EN, BYPASS_EN_HV, BYPASS_EN_HV_DEL, and BYPASS_EN_HV_Z are digital signals. Level shifter 320 also has inputs 320e and 320f. Input 320e is coupled to output 120e and receives output voltage VOUT and input 320f is coupled to output 122b of charge pump circuit 122 and receives voltage VOUT+5V.

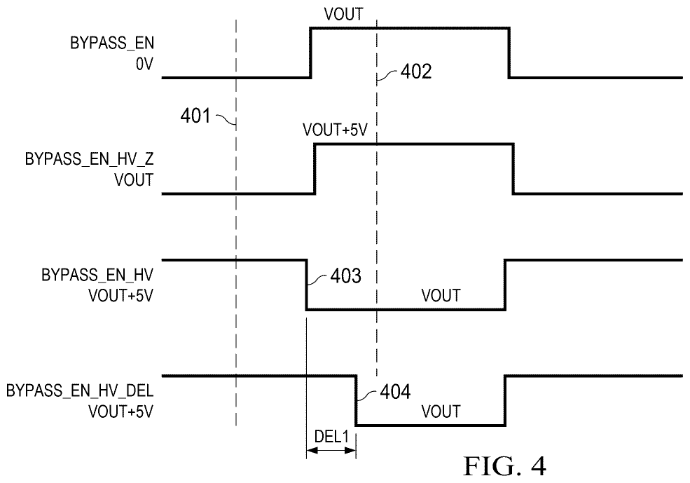

FIG. 4 includes example waveforms for signals BYPASS_EN, BYPASS_EN_HV_Z, BYPASS_EN_HV, and BYPASS_EN_HV_DEL. In one example, a logic low for signal BYPASS_EN is 0V, and a logic high for signal BYPASS_EN is the output voltage VOUT. Level shifter 320 generates digital signals BYPASS_EN_HV_Z, BYPASS_EN_HV, and BYPASS_EN_HV_DEL based on the voltage level of signal BYPASS_EN. In response to signal BYPASS_EN being at 0V, as identified by reference numeral 401, level shifter 320 generates signal BYPASS_EN_HV_Z at VOUT and signals BYPASS_EN_HV and BYPASS_EN_HV_DEL at VOUT+5V. In response to signal BYPASS_EN being at VOUT, as identified by reference numeral 402, level shifter 320 generates signal BYPASS_EN_HV_Z at VOUT+5V and signal BYPASS_EN_HV at VOUT. Level shifter 320 includes a falling edge delay circuit (described below) that delays the falling edge 404 for signal BYPASS_EN_HV_DEL relative to the rising edge 403 of signal BYPASS_EN_HV. In one example, the delay DEL1 is approximately 20 ns.

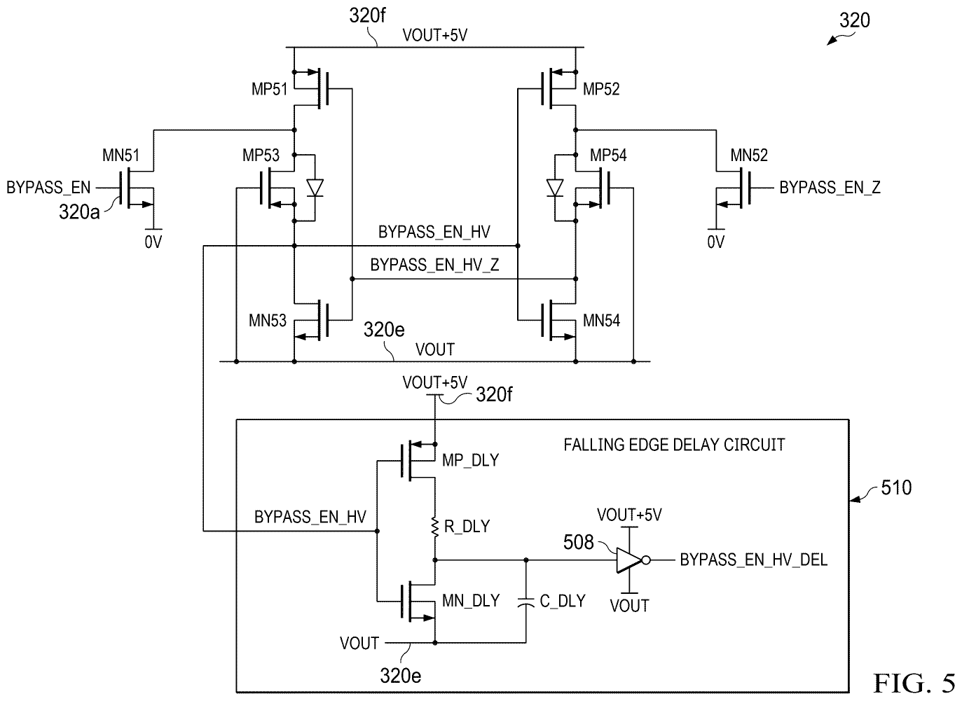

FIG. 5 is a schematic diagram of level shifter 320, in an example. Level shifter 320 includes transistors MP51, MP52, MP53, MP54, MN51, MN52, MN53, MN54, MP_DLY, and MN_DLY, resistor R_DLY, capacitor C_DLY, and inverter 508. Transistors MP51-MP54, and MP_DLY are PFETs, and transistors MN51-MN54 and MN_DLY are NFETs. The sources of transistors MP51 and MP52 are coupled together and to input 320f and, accordingly, receive voltage VOUT+5V from charge pump circuit 122. The drains of transistors MN51, MP51, and MP53 are coupled together, and the drains of transistors MN52, MP52, and MP54 are coupled together. The gate of transistor MN51 is coupled to input 320a and receives signal BYPASS_EN. The gate of transistor MN52 receives the logical inverse of signal BYPASS_EN, labeled as signal BYPASS_EN_Z in FIG. 5. The sources of transistors MN51 and MN52 are coupled to ground (0V).

The gates of transistors MP53 and MP54 are coupled to input 320c and receive voltage VOUT. The source of transistor MP53 is coupled to the drain of transistor MN53 and to the gates of transistors MP52 and MN54 and provides the signal BYPASS_EN_HV. The source of transistor MP54 is coupled to the drain of transistor MN54 and to the gates of transistors MP51 and MN53 and provides the signal BYPASS_EN_HV_Z.

The source of transistor MP53 is coupled to the gates of transistors MP_DLY land MN_DLY. One terminal of resistor R_DLY is coupled to the drain of transistor MP_DLY, and the other terminal of resistor R_DLY is coupled to the drain of transistor MN_DLY. The source of transistor MP_DLY is coupled to input 320f and receives voltage VOUT+5V. The source of transistor MN_DLY is coupled to input 320e and receives voltage VOUT. One terminal of capacitor C_DLY is coupled to the drain of transistor MN_DLY and to the input of inverter 508. The other terminal of capacitor C_DLY is coupled to input 320c. The power supply to inverter 508 is a higher voltage VOUT+5V and a lower voltage VOUT. The output of inverter 508 provides signal BYPASS_EN_HV_DEL.

When signal BYPASS_EN is 0V, transistor MN51 is off and transistor MN52 is on. Transistor MN52 being on causes the voltage on the drains of transistors MP52 and MP54 to be 0V, which causes the circuit to reach a state at which signal BYPASS_EN_HV is VOUT+5V and signal BYPASS_EN_HV_Z is VOUT. With signal BYPASS_EN_HV being at VOUT+5V, transistor MP52 is off and transistor MN54 is on. With transistor MN54 being on, the voltage on the drain of transistor MN54 (signal BYPASS_EN_HV_Z) is VOUT, which causes transistor MP51 to be on and transistor MN53 to be off. Further, the gate voltage of transistor MP53 is VOUT, and its source voltage is VOUT+5V thereby causing transistor MP53 to be on.

When signal BYPASS_EN is VOUT, transistor MN52 is off and transistor MN51 is on. Transistor MN51 being on causes the voltage on the drains of transistors MP51 and MP53 to be 0V, which causes the circuit to reach a state at which signal BYPASS_EN_HV is VOUT and signal BYPASS_EN_HV_Z is VOUT+5V. With signal BYPASS_EN_HV_Z being at VOUT+5V, transistor MP51 is off and transistor MN53 is on. With transistor MN53 being on, the voltage on the drain of transistor MN53 (signal BYPASS_EN_HV) is VOUT, which causes transistor MP52 to be on and transistor MN54 to be off. Further, the gate voltage of transistor MP54 is VOUT, and its source voltage is VOUT+5V thereby causing transistor MP54 to be on.

The combination of transistors MP_DLY and MN_DLY, resistor R_DLY, capacitor C_DLY, and inverter 508 is a falling edge delay circuit 510. Transistors MP_DLY and MN_DLY function as an inverter. When signal BYPASS_EN_HV is logic high (VOUT+5V), transistor MN_DLY is on and transistor MP_DLY is off. The input to inverter 508 is pulsed low to voltage VOUT through transistor MN_DLY, and the output signal, BYPASS_EN_HV_DEL, of inverter 508 is logic high as well (VOUT+5V). Upon occurrence of a falling edge of signal BYPASS_EN_HV, transistor MP_DLY turns on and transistor MN_DLY turns off. When transistor MP_DLY turns on, current flows through transistor MP_DLY and resistor R_DLY to charge capacitor C_DLY. The time constant controlling the rate at which the voltage across capacitor C_DLY rises is a function of the resistance of resistor R_DLY and capacitance of capacitor C_DLY, which sets the time delay DEL1 (FIG. 4). Eventually, the voltage to the input of inverter 508 is large enough to trip the inverter's output to becoming a logic low (VOUT). Upon the subsequent rising edge of signal BYPASS_EN_HV, transistor MP_DLY turns off and transistor MN_DLY turns on, thereby quickly pulling the input of inverter 508 to logic low (VOUT) without time delay DEL1.

HS and bypass driver 120 has four configurations in terms of which transistors are on and which transistors off. During boost mode, HS and bypass driver 120 has two configurations-one configuration in which HS and bypass driver 120 turns on HS transistor and another configuration in which HS and bypass driver 120 turns off HS transistor 125. In both configurations during boost mode, HS and bypass driver turns off bypass transistor 114. During bypass mode, HS and bypass driver 120 has a first configuration in which, at least to some extent, charge from capacitor C_FLY is used to charge the gate of bypass transistor 114 to turn on bypass transistor 114, and a second configuration in which the charge pump circuit 122 recharges capacitor C_FLY.

FIGS. 6, 7, 8, and 10 are identical to FIG. 3 and identify the on and off states of the transistors during each of the four configurations. An “X” across a transistor means that that transistor is off; otherwise, a transistor without an “X” is on. A transistor that is on is denoted with the word “ON.”

FIG. 6 represents the configuration of HS and bypass driver 120 during boost mode in which HS transistor 125 is off. During boost mode, to turn off HS transistor 125 and bypass transistor 114, mode control circuit 140 asserts signals HS_ON and BYPASS_EN to logic low levels. With signal BYPASS_EN at a logic low level, the output signal from inverter 325 is logic high thereby turning on transistor M5 and pulling signal BYPASS_GATE low and turning off, or maintaining off if already off, bypass transistor 114.

With signals HS_ON and BYPASS_EN at logic low level, the output signal from OR gate 321 is logic low, and the output signal from inverter 323 is logic high (VOUT). Further, the output signal from inverter 324 to the bottom terminal of capacitor C_FLY is 0V. The voltage across capacitor C_FLY remains at approximately voltage VOUT throughout operation of HS and bypass driver 120, and accordingly, the voltage at the opposing terminal of capacitor C_FLY is VOUT. The voltage at the source of transistor M7 is VOUT and, in the configuration of FIG. 6, the voltage at the gate of transistor M7 also is VOUT. Accordingly, the gate-to-source voltage (Vgs) of transistor M7 is 0V and transistor M7 is off. The voltage across capacitor C_AUX also remains at approximately voltage VOUT throughout operation of HS and bypass driver 120. With the voltage at the bottom terminal of capacitor C_AUX (output of inverter 323) is at VOUT, the voltage at the top terminal of capacitor C_AUX is 2*VOUT. With the source voltage of transistor M6 at VOUT and the gate voltage at 2*VOUT, the Vgs of transistor M6 is high enough such that transistor M6 is on. Capacitor C_FLY is charged to a voltage equal to VOUT.

Level shifter 320 controls the signal BYPASS_EN_HV_Z to the gate of transistor M1. As described above regarding FIGS. 4 and 5, when signal BYPASS_EN is logic low, the voltage level of signal BYPASS_EN_HV_Z is at VOUT. With the source voltage of transistor M1 also at VOUT, the Vgs of transistor M1 is 0V and transistor M1 is off. Level shifter 320 also controls the signal BYPASS_EN_HV to the gate of transistor M2. When signal BYPASS_EN is logic low, the voltage level of signal BYPASS_EN_HV is at VOUT+5V and, with the source voltage of transistor M2 at VOUT, transistor M2 also is off. Similarly, level shifter 320 generates signal BYPASS_EN_HV_DEL at a voltage of VOUT+5V. Charge pump circuit 122 generates its output voltage to be VOUT+5V and, accordingly, the Vgs of transistor M3 is 0V thereby causing transistor M3 to be off.

OR gate 322 logically ORs the output signal from inverter 323 with signal BYPASS_EN. The output signal of inverter 323 is a voltage VOUT, which causes the output signal from OR gate 322 to be large enough voltage to turn on transistor M4. With transistor M4 on, signal HS_GATE is pulled low thereby causing HS transistor 125 to be off.

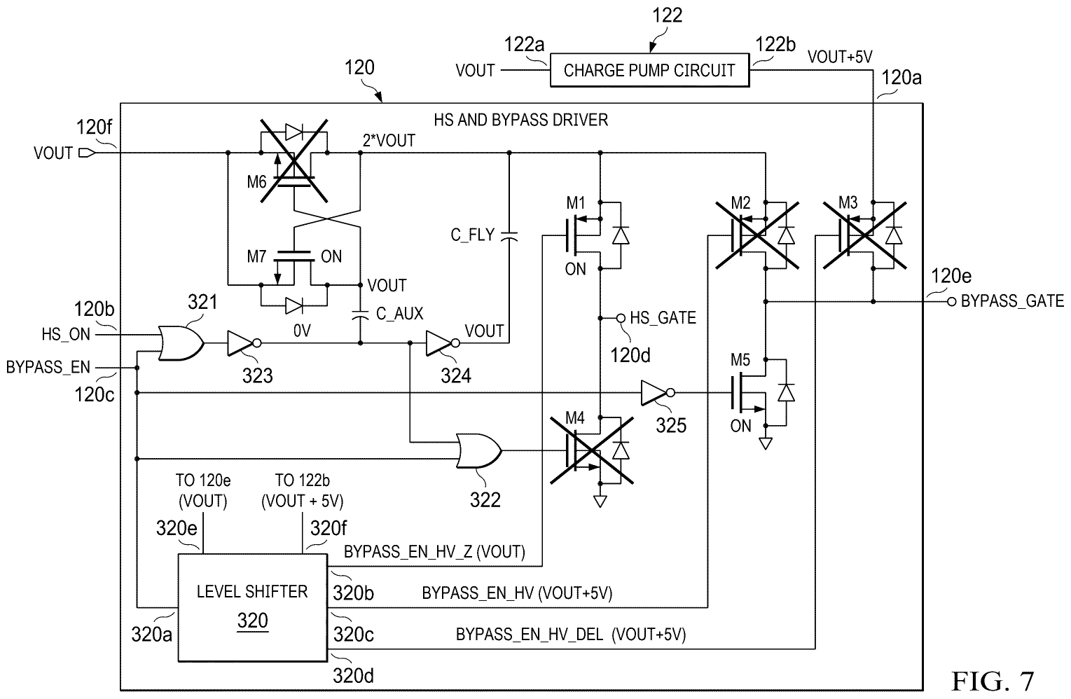

FIG. 7 illustrates the configuration of HS and bypass driver 120 during boost mode when HS transistor 125 is on. Mode control circuit 140 asserts signals HS_ON logic high (VOUT) and BYPASS_EN logic low. As described above, with signal BYPASS_EN at a logic low level, the output signal from inverter 325 is logic high thereby turning on transistor M5 and pulling signal BYPASS_GATE low and turning off, or maintaining off if already off, bypass transistor 114.

With signals HS_ON and BYPASS_EN at logic high and low levels, respectively, the output signal from OR gate 321 is logic high, and the output signal from inverter 323 is logic low (0V). Further, the output signal from inverter 324 to the bottom terminal of capacitor C_FLY is logic high (VOUT). Because the voltage across capacitor C_FLY remains at approximately voltage VOUT, the voltage at the opposing terminal of capacitor C_FLY is 2*VOUT. The voltage at the source of transistor M7 is VOUT and, in the configuration of FIG. 7, the voltage at the gate of transistor M7 is 2*VOUT. Accordingly, the Vgs of transistor M6 is VOUT and transistor M7 is on. Because the voltage across capacitor C_AUX remains at approximately voltage VOUT and the voltage at the output of inverter 323 is 0V, the voltage at the top terminal of capacitor C_AUX is VOUT. With the source voltage of transistor M6 at VOUT and the gate voltage at VOUT, the Vgs of transistor M6 is 0V and transistor M6 is off.

Level shifter 320 continues to generate the same voltages for signals BYPASS_EN_HV_Z (VOUT), BYPASS_EN_HV (VOUT+5V), and BYPASS_EN_DEL (VOUT+5V) as described above regarding FIG. 6 because signal BYPASS_EN remains at the same logic level (low, 0V). The voltage level of VOUT+5V is greater than 2*VOUT. Accordingly, transistors M2 and M3 are off. However, because the voltage at the source of transistor M1 is 2*VOUT while its gate voltage is VOUT, the Vgs of transistor M1 is greater than its threshold voltage and transistor M1 turns on. The input signals to inverter 323 are logic low, which causes the output signal from OR gate 322 to be logic low (0V) thereby turning off transistor M4. With transistor M4 off and transistor M5 on, signal HS_GATE is pulled upward toward voltage 2*VOUT thereby causing HS transistor 125 to turn on.

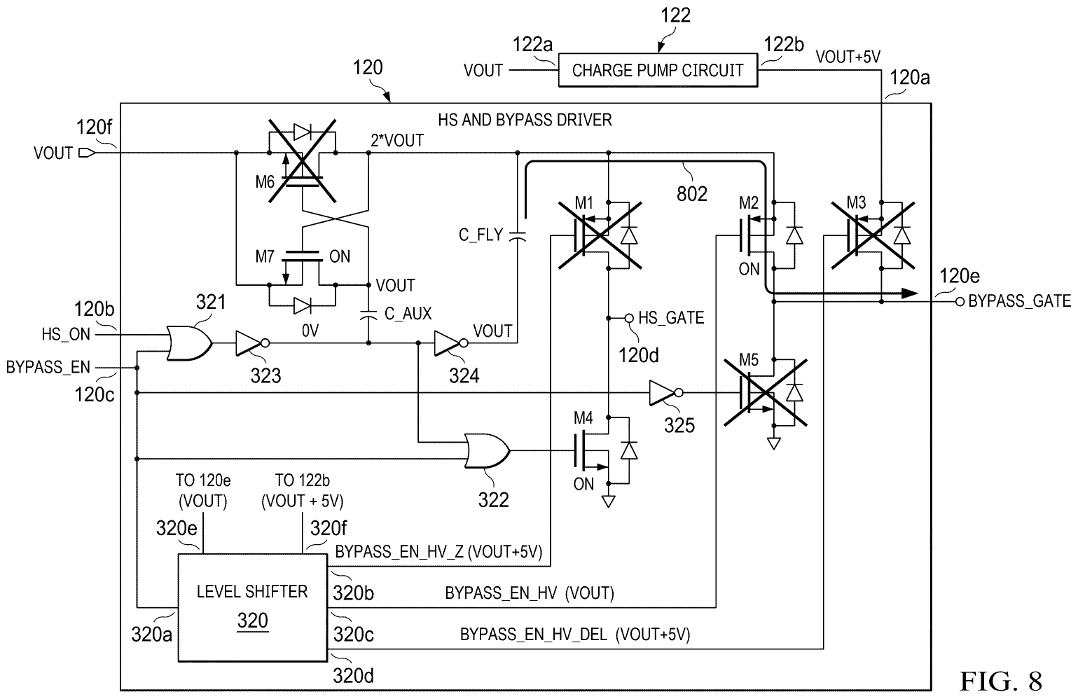

FIG. 8 illustrates the configuration of HS and bypass driver 120 during the initial part of the bypass mode. Mode control circuit 140 asserts signal HS_ON logic low and signal BYPASS_EN logic high (VOUT). As described above, level shifter 320 responds to signal BYPASS_EN having a voltage of VOUT by causing signal BYPASS_EN_HV_Z to have a voltage of VOUT+5V and signal BYPASS_EN_HV to a voltage of VOUT. Before the expiration of time delay DEL1 after falling edge 403 of signal BYPASS_EN_HV, signal BYPASS_EN_HV_DEL remains at a voltage of VOUT+5V. With the voltage at the sources of transistors M1 and M2 at 2*VOUT, transistor M1 turns off and transistor M2 turns on. Further, with signal BYPASS_EN being logic high, inverter 325 produces a logic low output signal turning off transistor M5. With transistor M2 on, capacitor C_FLY discharges some of its charge as current 802 through transistor M2 to the gate of bypass transistor 114.

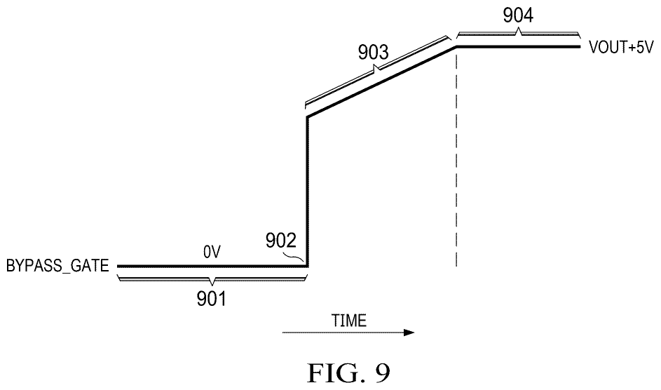

FIG. 9 is a graph of the voltage of signal BYPASS_GATE. Time portion 901 corresponds to signal BYPASS_EN being logic low and, as described above, HS and bypass driver 120 forces the voltage of signal BYPASS_GATE to be 0V. At time marker 902, mode control circuit 140 forces signal BYPASS_EN logic high, which, as explained with regard to FIG. 8, causes HV and bypass driver 120 to turn on transistor M2. With transistor M2 turned on, the gate capacitance of bypass transistor 114 begins to charge and signal BYPASS_GATE increases as indicated by reference numeral 903. When the gate capacitance of bypass transistor 114 is fully charged, signal BYPASS_GATE levels out as indicated by reference numeral 904.

The voltage level of signal BYPASS_GATE is VOUT+5V. The voltage at the source of bypass transistor 114 is VIN, which may vary, e.g., reduce as the battery charge depletes. HS and bypass driver 120 and charge pump circuit 122 function to regulate the voltage level of signal BYPASS_GATE to be 5V greater than VOUT, and VOUT is approximately equal to VIN. Accordingly, the Vgs of bypass transistor 114 is regulated to be at a fixed level, e.g., 5V. By regulating the Vgs of bypass transistor 114, the on-resistance of bypass transistor 114 is controlled to a consistent value. Further, the use of charge pump circuit 122 helps to ensure that the Vgs of bypass transistor 114 is at a sufficiently high value to result in a relatively low value for on-resistance of bypass transistor 114.

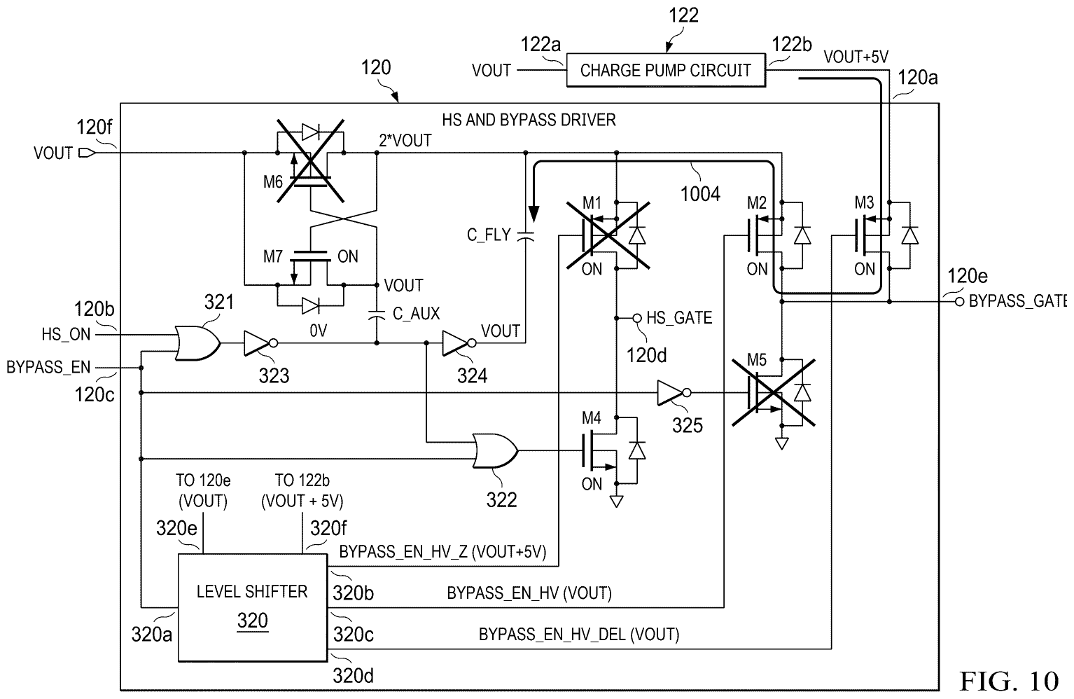

FIG. 10 illustrates the configuration of HS and bypass driver 120 during the bypass mode after time delay DEL1 has passed. Upon expiration of time delay DEL1, level shifter 320 forces signal BYPASS_EN_HV_DEL down to voltage VOUT. With the voltage of signal BYPASS_EN_HV_DEL to the gate of transistor M3 being VOUT and the source voltage of transistor M3 being VOUT+5V, transistor M3 turns on. With transistor M3 on, charge pump circuit 122 sources current 1004 through transistors M3 and M2 to recharge capacitor C_FLY.

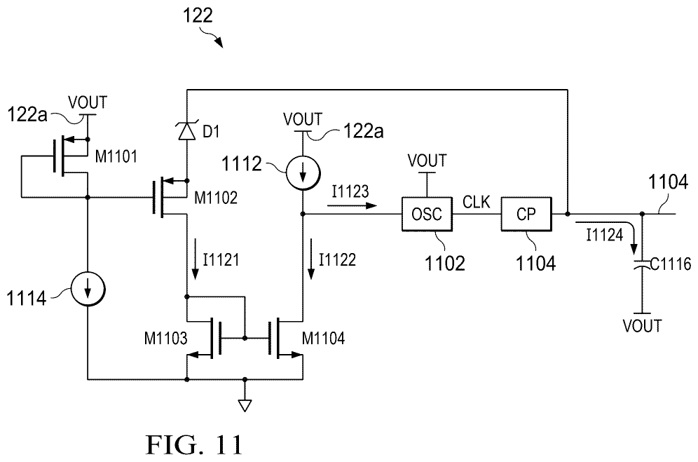

FIG. 11 is a schematic diagram of charge pump circuit 122, in an example. Charge pump circuit 122 includes an oscillator 1102, a charge pump 1104, transistors M1101, M1102, M1103, and M1104, diode DI, capacitor C1116, and current source circuits 1112 and 1114. Diode DI is a Zener diode. Oscillator 1102 generates a clock signal CLK to charge pump 1104, which, based on the clock signal CLK, generates a current 11124 at a level based on the frequency of the clock signal to charge capacitor C1116. The voltage at output 122b is regulated to be, for example, 5V above the voltage VOUT at the bottom terminal of capacitor C1116. That voltage is provided as a feedback voltage through Zener diode DI to the source of transistor M1102. Transistor M1101 is a diode-connected transistor whose gate and drain are coupled together. The source of transistor M1101 receives voltage VOUT. Diode-connected transistor M1101 provides a diode-voltage drop (e.g., 1V) from VOUT to the gate of transistor M1102.

The drain current 11121 through transistor M1102 is, in part, a function of the Vgs of transistor M1102. The gate voltage is a function of voltage VOUT, which may decrease as the power source (e.g., a battery) decreases over time as explained above. As VOUT changes, the gate voltage of transistor M1101 changes relative to its source voltage thereby causing a change in the drain current through transistor M1102. For example, as VOUT decreases, the Vgs of transistor M1102 increases and its drain current 11121 increases. Transistors M1103 and M1104 are coupled together to form a current mirror, which mirrors current 11121 as current 11122. Current source circuit 1112 provides a fixed current. With current 11122 varying based on changes in VOUT, the current 11123 to oscillator 1102 also varies. Changes in the current 11123 to oscillator 1102 cause the oscillator to vary the frequency of its clock signal CLK to charge pump 1104. In one example, as VOUT decreases, current 11121 increases thereby causing an increase in current 11122. An increase in current 11122 causes current 11123 to decrease. Oscillator 1102 responds to a decrease in current 11123 by reducing the frequency of its clock signal CLK to charge pump 1104. Charge pump 1104 responds to a decrease in the frequency of the clock signal CLK by reducing the charge current 11124 to capacitor C1116 thereby regulating the voltage across capacitor C1116 to be a fixed voltage (e.g., 5V) above voltage VOUT.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter.

References herein to a FET being “on” or “enabled” means that the conduction channel of the FET is present and drain current may flow through the FET. References herein to a FET being “off” or “disabled” means that the conduction channel is not present so drain current does not flow through the FET. An “off” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described examples, and other examples are possible, within the scope of the claims.

What is claimed is:

1. A circuit, comprising:
a first transistor having a first terminal and a second terminal;
a second transistor having a first terminal and a second terminal, the first terminal of the second transistor coupled to the first terminal of the first transistor;
a third transistor having a first terminal and a second terminal, the second terminal of the third transistor coupled to the second terminal of the second transistor;
a charge pump having an output coupled to the first terminal of the third transistor; and
a capacitor having a terminal coupled to the first terminal of the first transistor and to the first terminal of the second transistor.

2. The circuit of claim 1, further comprising:
a first logic gate having a first input, a second input, and an output;
a first inverter having an input and an output, the input of the first inverter coupled to the output of the first logic gate;
a second logic gate having a first input, a second input, and an output, the first input of the second logic gate coupled to the second input of the first logic gate, the second input of the second logic gate coupled to the output of the first inverter; and
a fourth transistor having a control input and a first terminal, the control input of the fourth transistor coupled to the output of the second logic gate, and the first terminal of the fourth transistor coupled to the second terminal of the first transistor.

3. The circuit of claim 1, wherein the first transistor has a second terminal, and the circuit further comprises:
a fourth transistor having a first terminal coupled to the second terminal of the first transistor; and
a fifth transistor having a first terminal coupled to the second terminal of the second transistor and to the second terminal of the third transistor.

4. The circuit of claim 1, further comprising:
a fourth transistor having a control input and a first terminal, the control input of the fourth transistor coupled to the second terminal of the second transistor and to the second terminal of the third transistor;
wherein the charge pump has an input coupled to the first terminal of the fourth transistor.

5. The circuit of claim 4, wherein the fourth transistor is an n-channel field effect transistor.

6. The circuit of claim 4, further comprising:
a fifth transistor having a control terminal and a first terminal, the control terminal of the fifth transistor coupled to the second terminal of the first transistor, and the first terminal of the fifth transistor coupled to the first terminal of the fourth transistor;
wherein the fourth and fifth transistors are n-channel field effect transistors.

7. The circuit of claim 6, wherein the fourth transistor has a second terminal, the fifth transistor has a second terminal, and the circuit further comprises:
an inductor having a first terminal and a second terminal, the first terminal of the inductor coupled to the second terminal of the fifth transistor, and the second terminal of the inductor coupled to the second terminal of the fourth transistor.

8. The circuit of claim 1, wherein the first transistor has a control input, the second transistor has a control input, and the third transistor has a control input, and the circuit further comprises:
a level shifter having an input, a first output, a second output, and a third output, the first output coupled to the control input of the first transistor, the second output coupled to the control input of the second transistor, and the third output coupled to the control input of the third transistor.

9. The circuit of claim 8, wherein the level shifter includes a delay circuit having an input coupled to the second output of the voltage level shifter, the delay circuit having the third output.

10. A voltage converter, comprising:
a boost converter having an input and an output;
a first transistor having a control input, a first terminal, and a second terminal, the first terminal coupled to the input of the boost converter, the second terminal coupled to the output of the boost converter;
a driver having a first input, a first output, and a second output, the first output coupled to the boost converter, and the second output coupled to the control input of the first transistor; and
a charge pump having an input and output, the input of the charge pump coupled to the output of the boost converter, and the output of the charge pump coupled to the first input of the driver.

11. The voltage converter of claim 10, wherein the first transistor is an n-channel field effect transistor.

12. The voltage converter of claim 10, wherein:
the boost converter has a high side (HS) transistor and a low side (LS) transistor, the HS transistor having a control input coupled to the first output of the driver;
the driver has a second input and a third input, the driver configured to:
in response to a first control signal at the second input being at a first logic state and a second control signal at the third input being at a second logic state, turn on the HS transistor and turn off the first transistor; and
in response to the first control signal being at a second logic state and the second control signal being at the first logic state, turn on the first transistor and turn off the HS transistor.

13. The voltage converter of claim 12, wherein the driver comprises:
a first transistor having a first terminal and a second terminal;
a second transistor having a first terminal and a second terminal, the first terminal of the second transistor coupled to the first terminal of the first transistor; and
a third transistor having a first terminal and a second terminal, the second terminal of the third transistor coupled to the second terminal of the second transistor.

14. The voltage converter of claim 13, wherein the first transistor has a control input, the second transistor has a control input, and the third transistor has a control input, and the voltage converter further comprising:
a level shifter having an input coupled to the third input of the driver, and having first, second, and third outputs coupled to respective control inputs of the first, second, and third transistors.

15. The voltage converter of claim 13, further comprising:
a logic circuit having a first input, a second input, and an output, the first input of the logic circuit coupled to the second input of the driver, the second input of the logic circuit coupled to the third input of the driver; and
a capacitor having a first terminal and a second terminal, the first terminal of the capacitor coupled to the first terminal of the first transistor and to the first terminal of the second transistor, and the second terminal of the capacitor coupled to the output of the logic circuit.

16. A voltage converter, comprising:
a boost converter having an input and an output and having a high side (HS) transistor having a control input;
a first transistor having a control input, a first terminal, and a second terminal, the first terminal coupled to the input of the boost converter, and the second terminal coupled to the output of the boost converter;
a charge pump having an input and output, the input of the charge pump coupled to the output of the boost converter; and
a driver having a first input, a second input, a third input, a first output, and a second output, the first input coupled to the output of the charge pump, the first output coupled to the control input of the HS transistor, and the second output coupled to the control input of the first transistor, the driver configured to:
in response to a first control signal at the second input being at a first logic state and a second control signal at the third input being at a second logic state, turn on the HS transistor and turn off the first transistor; and
in response to the first control signal being at a second logic state and the second control signal being at the first logic state, turn on the first transistor and turn off the HS transistor.

17. The voltage converter of claim 16, wherein:
the driver includes a capacitor; and
the charge pump is configured to charge the capacitor while turning on the first transistor.

18. The voltage converter of claim 16, wherein the first transistor is an n-channel field effect transistor.

19. The voltage converter of claim 16, wherein the driver comprises:
a first transistor having a first terminal and a second terminal;
a second transistor having a first terminal and a second terminal, the first terminal of the second transistor coupled to the first terminal of the first transistor; and
a third transistor having a first terminal and a second terminal, the second terminal of the third transistor coupled to the second terminal of the second transistor.

20. The voltage converter of claim 19, wherein the first transistor has a first control input, the second transistor has a second control input, and the third transistor has a third control input, and the voltage converter further comprises a level shifter coupled to the first, second, and third control inputs and configured to provide signals to the first, second, and third control inputs.
